(19) United States
(12) Patent Application Publication
(10) Pub. No.: US 2011/0051188 A1
(43) Pub. Date: Mar. 3, 2011

(54) PRINTING SYSTEM, DISTRIBUTING SERVER, PRINTING TERMINAL, METHOD FOR CONTROLLING DISTRIBUTING SERVER AND CONTROL PROGRAM, AND METHOD FOR CONTROLLING PRINTING TERMINAL AND CONTROL PROGRAM

(75) Inventors: Kiyoshi Yoda, Matsumoto-shi (JP); Takao Ozawa, Shiojiri-shi (JP)

(73) Assignee: SEIKO EPSON CORPORATION, Shinjuku-ku (JP)

(21) Appl. No.: 12/869,633

(22) Filed: Aug. 26, 2010

(30) Foreign Application Priority Data
Aug. 27, 2009 (JP) 2009-196438
Aug. 27, 2009 (JP) 2009-196439

(51) Int. Cl. G06F 3/12

(52) U.S. Cl. 358/1.15

(57) ABSTRACT

A printing terminal which is connectable to a distributing server via a communication line includes a limited number of times data receiving section which receives from the distributing server limited number of times data indicating a limit on the number of printing times of content data to be printed, an accepting section which accepts a user's operation to order printing of the content data, a content data receiving section which receives the content data, a printing section which carries out the printing of the content data upon the accepting section accepting the operation to order the printing, and a printing controller which prevents the content data from being printed by the printing terminal upon the number of printing times of the content data on the printing terminal reaching the limit on the number of printing times indicated by the limited number of times data after the printing is carried out.

### CROSS REFERENCES TO RELATED APPLICATIONS

The present invention contains subject matter related to Japanese Patent Application No. 2009-196439 and No. 2009-196438 filed in the Japanese Patent Office on Aug. 27, 2009, the entire contents of which are incorporated herein by reference.

### BACKGROUND

1. Technical Field

The present invention relates to a printing system which distributes content data to be printed to a printing terminal.

2. Related Art

It is disclosed in JP-A-2008-113422 to notify an addressee of facsimile communication of state data which indicates a state of a receiving device and is selected in accordance with a grouping of a transmitting device. The transmitting device can obtain the state data of the receiving device before transmitting image data. It is disclosed in JP-A-2009-93624 to set an available period of printing content data in a mechanism for distributing content data to be printed via the Internet, so as to prevent the content data from being dishonestly printed after the available period of the printing expires.

A service provider of content data distribution who is ready to distribute content data wants to specify a mode of distribution or a mode of printing in accordance with what is included in the content data. To put it specifically, e.g., the service provider wants an important document to be “certainly printed as soon as after distribution”, or wants to “manage content data which requires copyright protection on a server and transmit the content data only if a user requests printing”, etc. Meanwhile, someone on a side of receiving content data wants to “automatically print the content data upon receiving the content data”, or to “preview what is included upon receiving the content data and choose and print what is required to be printed”, etc. Although a device on the receiving side (printing terminal) is ordinarily provided with such a mechanism to meet the needs of the receiving side, there is no mechanism to meet the needs of the distributing side of the content data.

### SUMMARY

An advantage of some aspects of the invention is that a printing system can prevent a printing terminal from carrying out printing of content data beyond the limited number of printing times ordered by the distributing side of the content data.

(1) A printing system which achieves the advantage has a distributing server and a printing terminal which is connectable to the distributing server via a communication line. The printing terminal has a limited number of times data receiving section which receives from the distributing server limited number of times data indicating a limit on the number of printing times of content data to be printed. The printing terminal has an accepting section which accepts a user's operation to order printing of the content data. The printing terminal has a content data receiving section which receives the content data. The printing terminal has a printing section which carries out the printing of the content data. The printing terminal has a printing controller which prevents the content data from being printed by the printing terminal upon the number of printing times of the content data on the printing terminal reaching the limit on the number of printing times indicated by the limited number of times data after the printing is carried out.

According to the invention, content data for which the number of printing times is limited as specified by a distributing side of the content data can be prevented from being printed by a printing terminal beyond the limited number of times. Further, the printing terminal can be configured not to receive the content data from a distributing server until the printing terminal accepts an operation to order the printing. In this case, the printing terminal can make a period of time in which the printing terminal holds the content data shorter than that of a configuration such that the printing terminal receives the content data before accepting the operation to order the printing. Thus, the printing terminal can prevent the content data from being copied and appropriated, etc. Further, the printing terminal can save memory resources.

(2) The printing controller of the printing system which achieves the above advantage can discard the content data from the printing terminal upon the number of printing times reaching the limit on the number of printing times.

According to the configuration, as the content data is automatically discarded after the number of printing times reaches the limit on the number of printing times, the printing terminal can make a period of time in which the printing terminal holds the content data shorter than that of a configuration such that the content data is not discarded after the number of printing times reaches the limit. Thus, the printing terminal can prevent the content data for which the number of printing times exceeds the limit from being printed again and appropriated, etc. Further, the printing terminal can save memory resources.

Incidentally, the invention can be applied to a single distributing server or printing terminal as well as to the whole printing system described above. Further, the invention can be applied as a method or program for performing the process described above. Further, the distributing server can be variously configured to be implemented as a single device in one case and as a plurality of devices in another case, and so can the printing terminal, the method and the program. Further, they can be properly modified in such a way that a portion and another portion of them are implemented by software and hardware, respectively. Further, the invention can be formed as a recording medium in which the above program is recorded. The recording medium can be a magnetic or magneto-optical recording medium as a matter of course, and any recoding medium which will be developed from this time can be entirely regarded in the same light. Further, an order of operation described in a claim is not limited to the order of description as long as there are no technical obstructions. The operation can be performed simultaneously, in reverse order with respect to the described order, or can be performed discontinuously.

### BRIEF DESCRIPTION OF THE DRAWINGS

The invention will be described with reference to the accompanying drawings, wherein like numbers reference like elements.

FIG. 1 is a block diagram of a printing system of an embodiment of the invention.

FIG. 2 is a sequence diagram of the embodiment of the invention.

FIG. 3 is a sequence diagram of the embodiment of the invention.

FIG. 4 is a sequence diagram of the embodiment of the invention.

FIG. 5 is a sequence diagram of the embodiment of the invention.

### DESCRIPTION OF EXEMPLARY EMBODIMENTS

An embodiment of the invention will be explained with reference to the drawings in the following order, wherein like portions in the drawings are given like reference numerals, and redundant explanations will be omitted.

### 1. First Embodiment

### 1-1. Configuration

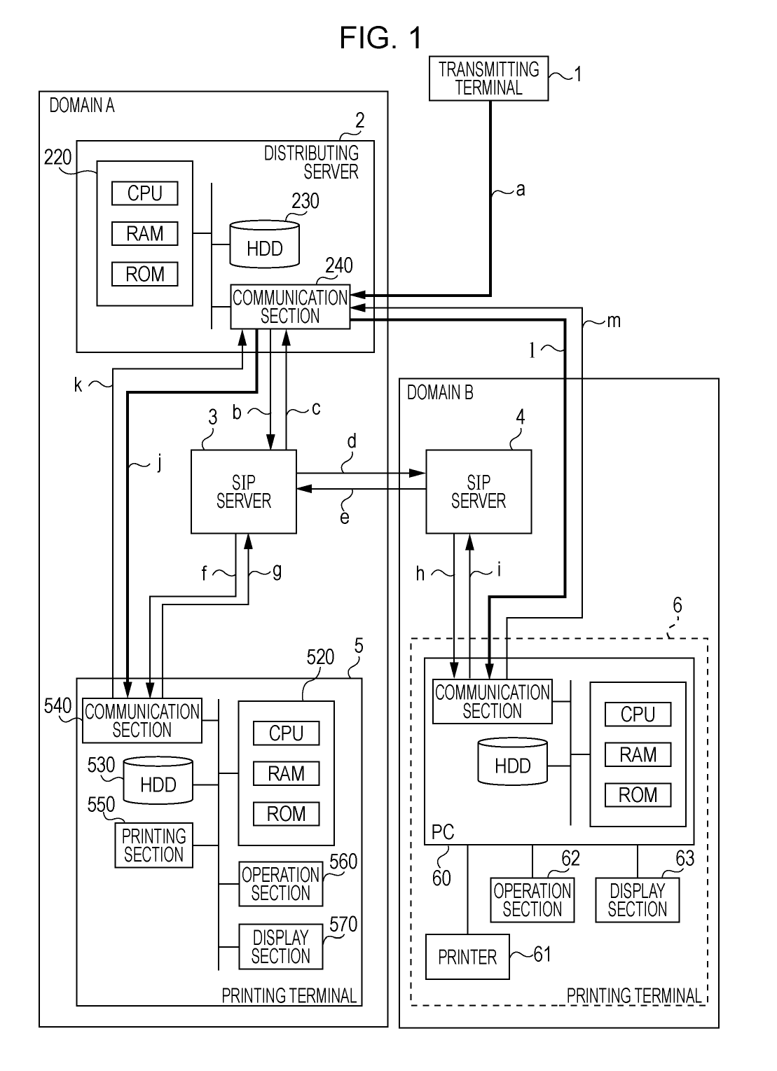

FIG. 1 is a block diagram for schematically showing a configuration of a printing system of a first embodiment of the invention. As shown in FIG. 1, the printing system of the embodiment is constituted by a transmitting terminal 1 managed by a company who wants to distribute printing content (an advertisement, mail-teaching materials, etc.) (called the distribution service provider hereafter), a distributing server 2 and SIP (Session Initiation Protocol) servers 3, 4 managed by a network service provider, and printing terminals 5, 6 managed by respective clients. Incidentally, the distributing server 2 and the SIP servers 3, 4 can be individually managed by different network service providers, or can be managed by a same network service provider. The distributing server 2, the SIP servers 3, 4 and the printing terminals 5, 6 are connected to one another via a so-called broadband network including the Internet. Further, the transmitting terminal 1 can be similarly connected to the distributing server 2 via the broadband network, or can be connected to the distributing server 2 via a dedicated line, etc. The printing terminal 5 corresponds to a printing terminal. The distributing server 2 corresponds to a distributing server.

Further, it is assumed that the distributing server 2, the SIP server 3 and the printing terminal 5 belong to a domain A, and that the SIP server 4 and the printing terminal 6 belong to a domain B, as explained below. That is, the distributing server 2 and the printing terminal 5 are SIP clients of the SIP server 3, and the printing terminal 6 is an SIP client of the SIP server 4.

According to the embodiment, the distribution service provider prepares content data to be printed such as a cooking recipe, an advertising poster or mail-teaching materials. Further, the distribution service provider also prepares a destination list and distribution data of the above content data in advance. Then, the content data, the destination list and the distribution data are transmitted from the transmitting terminal 1 to the distributing server 2, and distributed from the distributing server 2 to the printing terminals 5 and 6 individually on the basis of the destination list.

As a data format of the content data, various kinds of data formats to represent an image or a document such as JPEG data, GIF data, PNG data, TIFF data, plain text data, HTML data, PDF data, PostScript (registered trademark) data, etc. can be used. Further, if a type of a printer, etc. used by the printing terminal is known, the content data can be distributed in a form of printing data.

According to the embodiment, the distributing server 2 distributes the distribution data corresponding to the content data to the printing terminals 5, 6 on the basis of the destination list before the above content data is distributed to the printing terminals 5, 6 on the basis of the destination list. The distribution data includes data concerning a request for carrying out printing of the content data (request data) and data indicating a limit on the number of printing times of the content data (limited number of times data), as described later in detail, in addition to a title, a text to explain the content and thumbnails of the content data, the date and time of distribution, an SIP address of an addressee's printing terminal, an SIP address of the distributor's distributing server, etc. The request data and the limited number of times data will be described later.

As shown in FIG. 1, the distributing server 2 is constituted by a server computer. The distributing server 2 has main portions such as a controller 220 having a CPU, a ROM and a RAM and being configured to carry out various processes and control operations by running programs, a communication section 240 which transfers various data and pieces of information to and from other devices via a communication line, and an HDD 230 in which the programs used by the controller 220, data or pieces of information are stored. The controller 220 can run a distributing server control program as one of the programs, and functions at this time as a means for distributing the request data, a means for distributing the limited number of times data and a means for distributing the content data. The content data, the distribution data and the destination list transferred from the transmitting terminal 1 can be stored in the HDD (Hard Disk Device) 230 as the data or pieces of information. Incidentally, the distributing server 2 has an operation section such as a keyboard and a pointing device and a display section such as a display which are not shown in the drawing as well as the above portions. The controller 220 corresponds to a limited number of times data distributing section and a content data distributing section.

Further, according to the embodiment, a signaling protocol SIP is used before the distribution data and the content data described above are distributed, so that a session is established between the distributing server 2 and the printing terminal. After the session is established, a data transfer protocol HTTP (Hypertext Transfer Protocol) is used for distributing the distribution data and the content data.

The SIP servers 3 and 4 have following five main functions. They are a function for accepting a request for registration from an SIP client and for registering an SIP address (i.e., an SIP URI (Uniform Resource Identifier)) or position data (an IP (Internet Protocol) address, etc.) of the SIP client in a location server (a registrar), a function as a database in which the SIP addresses and the position data of the SIP client and the server are stored (a location server), a function for relaying a request or a response and arranging to establish a session between the Sip clients (a proxy server), a function for replying to an inquiry from the SIP client with position data of a communication partner (a redirect server), and a function for obtaining and managing data concerning a state of the SIP client (e.g., whether being powered on or off) and for providing another SIP client with the data (a presence server).

The SIP servers 3, 4 are constituted by server computers similarly as the distributing server 2. Each of the SIP servers 3, 4 has main portions such as a controller having a CPU, a ROM and a RAM and being configured to carry out various processes and control operations by running programs, a communication section which transfers various data and pieces of information to and from other devices via a communication line, and an HDD in which the programs used by the controller, data or pieces of information are stored. Registration data of an SIP client, printing terminal state data, etc. collected by the above functions can be stored in the HDD as the pieces of information. The registration data is specifically an SIP URI and an IP address of the SIP client. The printing terminal state data is data concerning a state of a printing terminal, and is specifically a state as to whether the printing terminal is powered on or off, a state of printer supplies, etc. Incidentally, each of the SIP servers 3, 4 has an operation section such as a keyboard and a pointing device and a display section such as a display as well as the above portions.

Various forms of configurations can be employed for the printing terminals 5, 6. It is assumed for the embodiment that the printing terminal 5 is constituted as a printer adapted for IP communication (or can be a multifunction printer adapted for IP communication), and that the printing terminal 6 is constituted as a printer or a multifunction printer directly connected to a personal computer (PC) via a USB (Universal Serial Bus), as explained below.

The printer adapted for IP communication (printing terminal 5) has a controller 520 provided with a CPU, a RAM and a ROM, an HDD 530, a communication section 540, a printing section 550, an operation section 560 such as a key panel, and a display section 570 such as an LCD. The controller 520 of the printing terminal 5 works as a means for receiving request data, a means for receiving limited number of times data, a means for receiving content data, a means for controlling printing and a means for acceptance by running a printing terminal control program. As being capable of directly handling a global address such as an SIP URI, the printer adapted for IP communication can be directly connected to a broadband network such as the Internet via a broadband router that is not shown, so as to exchange data to and from a device on the network. The controller 520 corresponds to a limited number of times data receiving section, an accepting section, a content data receiving section, a printing controller and a request data receiving section. The printing section 550 corresponds to a printing section.

The printing terminal 6 is constituted mainly by a PC 60 and a printer 61. The PC 60 has a controller 620, an HDD 630 and a communication section 640. The controller 620 can run a printing terminal control program, and works at this time as a means for receiving request data, a means for receiving limited number of times data, a means for receiving content data, a means for controlling printing and a means for acceptance. Further, the PC 60 is connected with the printer 61 via an interface that is not shown, and can transfer from the controller 620 to the printer 61 content data or printing data of a printing format of the printer 61 into which the content data is converted. Further, the PC 60 is connected with an operation section 62 such as a keyboard or a pointing device and a display section 63 such as a display via an interface that is not shown.

A user of the printing terminal 5 can choose an automatic printing mode in which the printing terminal 5 automatically prints received content data regardless of whether a user operates to order printing, and a manual printing mode in which the printing terminal 5 carries out printing in response to an operation of the user to order printing. If the user operates to choose one of the modes by using the operation section 560, the controller 520 can accept the choosing operation and set the printing terminal 5 in the mode chosen by the user. Further, as to the printing terminal 6, the PC 60 can present a UI (User Interface) for allowing the user to choose one of the automatic and manual printing modes on the display section 63 as a function of the printing terminal control program run by the PC 60, so as to accept the choosing operation of the user and to set the printing terminal 6 in the mode chosen by the user.

Apart from the configuration described above, the printing terminal can be constituted, e.g., by a PC and a multifunction printer adapted for networking connected to the PC via a LAN (Local Area Network) by a LAN cable, etc. Further, the printing terminal can be constituted by a PC, a network adaptor connected to the PC via a LAN (Local Area Network) by a LAN cable, etc., and a multifunction printer or a printer connected to the network adaptor by a USB cable, etc. The devices can be connected with one another by radio such as a so-called wireless LAN, Bluetooth or infrared ray system instead of by wired connection such as cables. Incidentally, network address translation (NAT) from a global IP address into a private IP address in the LAN and vice versa can be solved by known arts.

### 1-2. Distribution, Printing

### SIP Client Registration

According to the embodiment, a signaling protocol SIP is used for establishing a session between the distributing server 2 and the printing terminal, and a data transfer protocol HTTP is used for distributing the distribution data and the content data. To begin with, the distributing server 2 or the printing terminal 5 accesses, as an SIP client, the SIP server 3 which belongs to the same domain (b, g). The printing terminal 6 similarly accesses, as an SIP client, the SIP server 4 which belongs to the same domain (i). Then, each of the distributing server 2, the printing terminals 5, 6 requests registration from the accessed SIP server 3, 4, and transmits data such as own SIP URI or IP address (b, g, i). Each of the SIP servers 3, 4 functions as the registrar or the location server. Each of the SIP servers 3, 4 accepts the data such as the above SIR URI or IP address via the communication section, and registers the data in the own HDD.

As a result, the SIP server 3 holds the registration data of the distributing server 2 and the printing terminal 5 which belong to the same domain. The SIP server 4 similarly holds the registration data of the printing terminal 6 which belongs to the same domain. The registration data of each of the terminals is its SIP URI and its IP address related to each other.

### Session Establishment

The distribution service provider prepares content data to be distributed as content to be printed, distribution data corresponding to the content data and a destination list. The distribution service provider transmits the content data, the distribution data and the destination list to the distributing server 2 by using the transmitting terminal 1 in advance (a). The distribution service provider transmits them from the transmitting terminal 1 to the distributing server 2 by using, e.g., an HTTP or FTP protocol.

The controller 220 of the distributing server 2 analyzes the destination list received from the transmitting terminal 1. The destination list of the embodiment includes SIP URI of the printing terminals 5, 6 as the destinations. The controller 220 transmits a request to the SIP server 3 which belongs to the same domain as that of the distributing server 2 (b) so as to establish a session between the distributing server 2 and the printing terminal in accordance with the destination list. The SIP server 3 relays the request to the printing terminal 5 which belongs to the same domain on the basis of the registration data (f). Upon receiving the request, the printing terminal 5 transmits a response back to the SIP server 3 (g). The SIP server 3 relays the request to the distributing server 2 (c).

As the SIP server 3 does not hold registration data as to the printing terminal 6 which belongs to a domain different from that of the SIP server 3, the SIP server 3 transfers the request to the SIP server 4 which belongs to the same domain as that of the printing terminal 6 (d). As the SIP server 4 has the registration data as to the printing terminal 6 which belongs to the same domain as that of the SIP server 4, the SIP server 4 relays the transferred request to the printing terminal 6 on the basis of the registration data (h). The printing terminal 6 transmits to the SIP server 4 a response to the request addressed back to the distributing server 2 (i). As the SIP server 4 has no registration data as to the distributing server 2, the SIP server 4 transfers the response to the SIP server 3 which belongs to the same domain as that of the distributing server 2 (e). The SIP server 3 transfers the response to the distributing server 2 (c). The requests and responses are exchanged between the distributing server 2 and the printing terminals 5, 6 via the SIP servers 3, 4, as described above, so that sessions are established between the both.

### Distribution of Distribution Data and Content Data

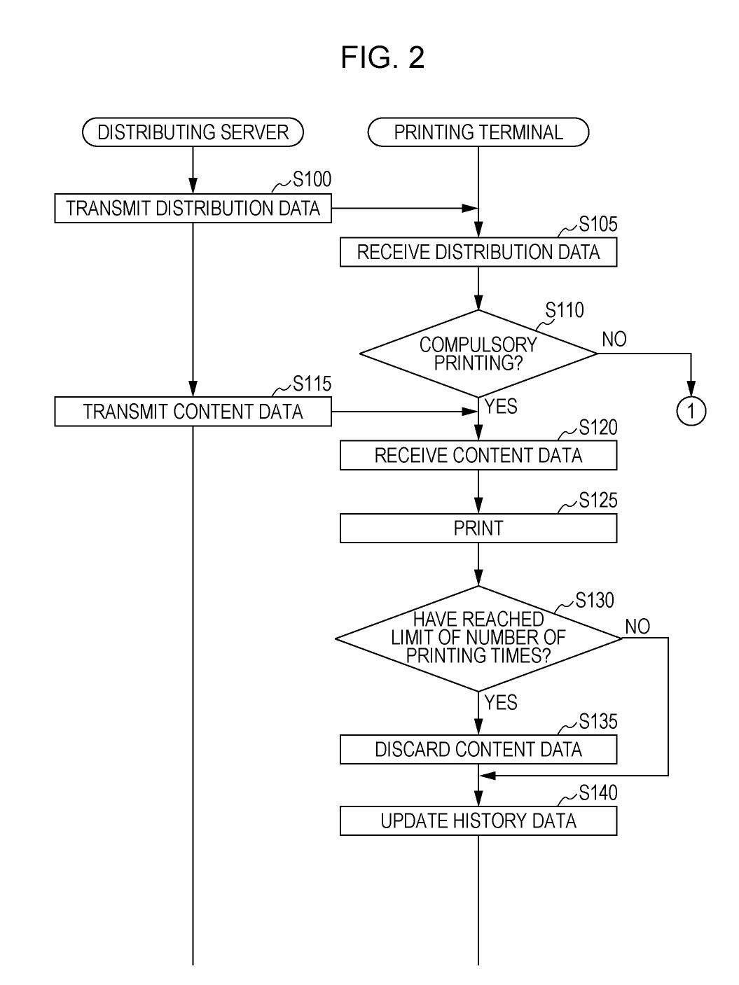

If the sessions are established between the distributing server 2 and the printing terminals 5, 6, the distributing server 2 directly accesses the printing terminals 5, 6 not through the SIP servers 3, 4 on the basis of the IP addresses of the printing terminals 5, 6, so that data can be exchanged in accordance with the HTTP (j, k, l, m). FIGS. 2 to 5 show a communication sequence between the distributing server 2 and the printing terminal 5. As a communication sequence between the distributing server 2 and the printing terminal 6 is a same as shown there, its explanation is omitted. To begin with, the controller 220 of the distributing server 2 controls the communication section 240 so as to transmit the destination data to the printing terminal as push-transmission (j, step S100). According to the “push-transmission”, the distributing server 2 unilaterally transmits and distributes data to the terminal even if the printing terminal does not request the data. If the communication section 540 of the printing terminal 5 receives the content data, the controller 520 once stores the received distribution data in the HDD 530 (step S105). Then, the controller 520 reads the distribution data from the HDD 530, and analyzes the content of the distribution data. The distribution data includes the request data and the limited number of times data, as described above.

The request data relates to a request to the printing terminal to carry out printing of the content data, and is specified on the distributing side (the distribution service provider) of the content data. The printing terminal carries out (or does not carry out) printing in accordance with the request specified by the distributing side. How the printing terminal is requested to carry out the printing as specified by the request data is, roughly speaking, either being requested to carry out the printing irrelevantly to a user's operation to order the printing or being requested otherwise. It can be supposed that the printing terminal is requested to carry out the printing in various ways depending upon when or whether the printing is carried out. The various ways which can be supposed are such that the distributing side requests the printing terminal to compulsorily print the content data regardless of whether the user operates to order the printing as soon as the printing terminal receives the content data, that the distributing side requests the printing terminal to compulsorily print the content data regardless of whether the user operates to order the printing after a certain lapse of time since the printing terminal receives the content data or at a time specified in advance, that the distributing side requests the printing terminal to compulsorily print the content data regardless of whether the user operates to order the printing if the content data is not printed after a certain lapse of time since the printing terminal receives the content data, and that the distributing side does not request the printing in particular and whether the printing terminal carries out the printing depends upon whether the user operates to order the printing. The request data of the embodiment indicates either that “compulsory printing” is ordered such that the printing terminal is made compulsorily print the content data regardless of any conditions on the printing terminal side as soon as receiving the content data (compulsory printing flag=on), or that the “compulsory printing” is not ordered (compulsory printing flag=off, i.e., to follow settings on the printing terminal side or the user's operation).

The limited number of times data indicates a limit on the number of printing times of the content data for each of the printing terminals specified by the distributing side of the content data. The printing terminal is controlled so as not to be allowed to print the content data more times than the limit specified by the distributing side. Although the number of printing times is not limited to a particular number, it is assumed that the limited number of times data of the embodiment specifies whether the number of printing times is limited to one or more than one and unlimited. Further, it is assumed as to the embodiment as explained below that, if the number of printing times is limited to one, the content data is discarded after being received and printed once. Incidentally, the printing terminal can be controlled so as not to be allowed to print the content data more times than the limit specified by the distributing side in other ways such that the content data is maintained by the printing terminal without being discarded and cannot be printed again until a password issued by the distribution service provider is input to the printing terminal 5, or that the printing terminal accepts neither an operation to order printing, an operation to copy the content data onto an external recording medium nor an editing operation, except for the user's deleting operation.

Then, the controller 520 identifies whether the request data orders compulsory printing (step S110). So as to make the printing terminal compulsorily print the content data, the controller 220 of the distributing server 2 transmits distribution data to which request data ordering the compulsory printing is set at the step S100, and then transmits content data corresponding to the distribution data to the printing terminal 5 as push-transmission (j, step S115). Incidentally, upon finishing analysis of the distribution data at the step S105 and identifying the compulsory printing specified in the distribution data, the controller 520 of the printing terminal 5 can transmit to the distributing server 2 a request to distribute the content data (k), and the distributing server 2 can transmit the content data upon receiving the request (j).

Upon receiving at the step S105 the distribution data ordering the compulsory printing of the content data corresponding to the distribution data, the controller 520 of the printing terminal 5 receives the content data via the communication section 540, and stores the content data in the HDD 530 (step S120). Then, the controller 520 transfers printing data produced on the basis of the content data stored in the HDD 530 to the printing section 550, makes the printing section 550 carry out printing on the basis of the printing data (step S125), and incrementally updates the number of printing times by one.

Then, the controller 520 identifies whether the number of printing times of the content data has reached the limit of the number of printing times shown by the limited number of times data of the distribution data (step S130). If the number of printing times has reached the limit, the controller 520 discards the content data from the RAM and the HDD 530 (step S135). That is, the step S135 is carried out if the compulsory printing is specified by the request data and the number of printing times is limited to one by the limited number of times data. Unless the number of printing times has reached the limit, the content data is maintained in the HDD 530 of the printing terminal 5 without being discarded. That is, if the compulsory printing is specified by the request data and the number of printing times is not specified (the number of printing times is unlimited) by the limited number of times data, the content data is maintained in the HDD 530 without being discarded.

Then, the controller 520 updates history data (step S140). The history data shows various histories on the printing terminal 5, and is stored in the HDD 530. To put it specifically, the history data includes the date and time of receiving the distribution data or the content data, a title of or text to explain the content data, the number of printing times of the content data (already printed/not printed yet) or whether the content data is discarded. Thus, the controller 520 updates the history data at the timing of receiving the content data, printing the content data, discarding the content data, or finishing receiving the distribution data only as described later. Further, the controller 520 displays the history data on the display section 570 at the timing of updating the history data or accepting a display request from a user of the printing terminal.

According to the embodiment, as described above, upon receiving the content data for which compulsory printing is specified by the distribution service provider, the printing terminal can print the content data immediately after receiving the content data, regardless of whether the printing terminal is set in the automatic printing mode or in the manual printing mode. That is, how the printing terminal carries out printing can be controlled as ordered by the distributing side of the content data. Further, the printing terminal 5 can be configured, if the distribution service provider limits the number of printing times to one, to discard the content data after carrying out the printing and not to print the content data twice or more beyond the limit. That is, the distributing side can order and control the printing terminal as to how the printing terminal deals with the distributed content data after the printing.

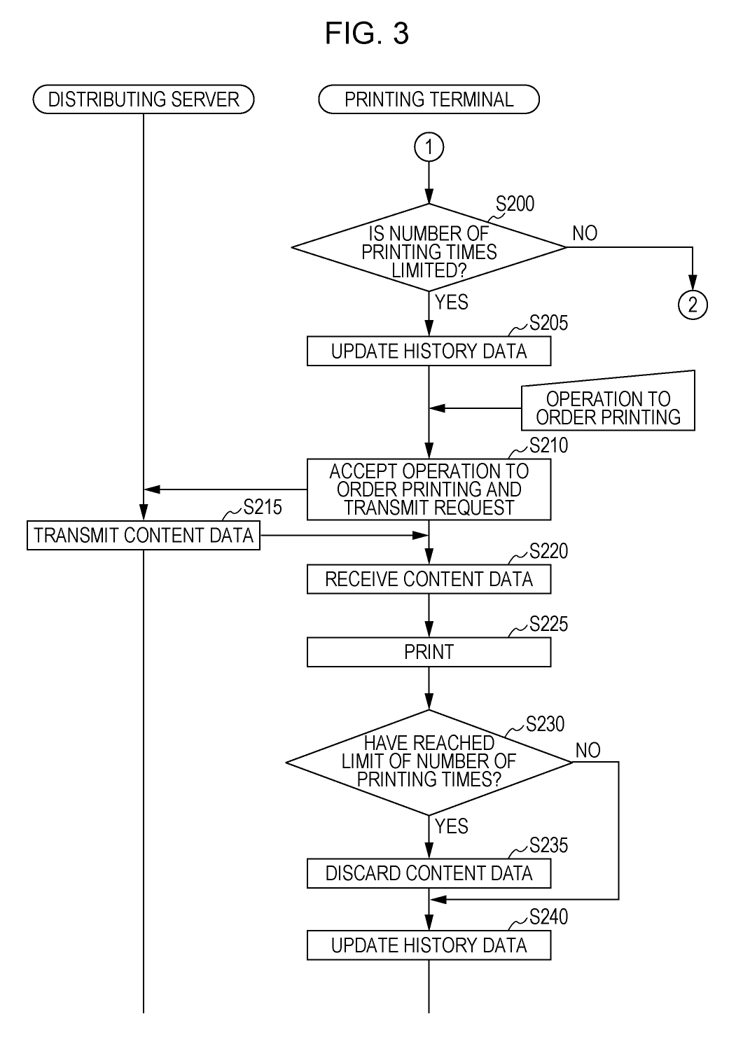

Upon identifying the request data as not ordering compulsory printing as a result of the analysis of the received distribution data at the step S110, the controller 520 identifies whether the number of printing times is limited as the limited number of times data (FIG. 3, step S200). If printing is carried out in a case where the number of printing times is limited, the number of printing times is incrementally updated even if printing quality is lower than quality supposed by the distribution service provider owing to, e.g., a wrong kind of printing paper. Thus, the printing terminal is configured to carry out printing in accordance with an operation of the user to carry out the printing as described later regardless of whether the printing terminal 5 is set in the automatic printing mode or in the manual printing mode, so that the user can check the kind of paper before starting the printing. Incidentally, the limited number of times data can be included in the request data to be specified. Upon identifying the limit as being set at the step S200, the controller 520 updates the history data (step S205). To put it specifically, the controller 520 updates the history data by adding data such as the date and time of receiving the content data with the limited number of printing times and the title of the content data. Then, the controller 520 presents a fact, via the display section 570, that the distribution data of the content data with the limited number of printing times has reached the printing terminal 5. Incidentally, the title, explaining text, thumbnails, date and time of distribution of the distribution data, etc. of the content data can be presented together.

Then, the controller 520 waits for the user to operate to order the printing terminal 5 to print the content data corresponding to the distribution data described above. If the user operates to order the printing, the controller 520 accepts the operation and transmits a request to the distributing server 2 so as to request distribution of the content data (k, step S210). Incidentally, the controller 520 can be configured to cancel the session once upon finishing the process of the step S205, and to reestablish a session with the distributing server 2 before the step S210. Upon accepting the request described above via the communication section 240, the controller 220 of the distributing server 2 distributes the content data to the printing terminal 5 (j, step S215).

Upon receiving the content data from the distributing server 2 via the communication section 540 (step S220), the controller 520 of the printing terminal 5 produces printing data on the basis of the received content data, transfers the printing data to the printing section 550 so as to carry out printing (step S225), and incrementally updates the number of printing times. Then, the controller 520 identifies whether the number of printing times has reached the limit on the number of printing times (step S230). In case of yes, the controller 520 discards the content data from the RAM and the HDD 530 (step S235). As it is assumed for the embodiment either that the number of printing times is limited to one or that an unlimited number of printing times is allowed, the content data is automatically discarded after the printing is carried out at the step S225. Then, the controller 520 updates the history data (step S240). To put it specifically, the controller 520 updates data concerning a fact that the content data has been printed or whether the content data has been discarded. Incidentally, the embodiment is configured, if the number of printing times is limited, to carry out printing as ordered by the user regardless of whether the printing terminal is set in the automatic printing mode or in the manual printing mode. The embodiment can be configured, however, in accordance with the mode in which the printing terminal 5 is set in such a way that the printing terminal 5 carries out the printing in response to the operation to order the printing similarly as described above in the manual printing mode, and that the controller 520 skips the step S205 and transmits a request to the distributing server 2 for distribution of the content data without waiting for the user to operate to order printing at the step S210 in the automatic printing mode. In this case, the operations at and following the step S215 are same as the contents and flow of the previously explained processes except that the step S240 also includes the process explained as to the step S205. Further, the embodiment can be configured in such a way that, in case of the limited number of printing times, the user can choose whether to obey setting of the modes on the printing terminal in advance.

If the distribution service provider limits the number of printing times to one, as described above, the printing terminal 5 can discard the content data after carrying out the printing and avoid printing the content data beyond the limit. Besides, only distribution data of content data for which the number of printing times is limited is transmitted to the printing terminal 5 first so as to inform the user of the presence of the content data waiting to be printed, and the content data is not distributed until a distribution request is accepted upon the user operating to order printing, so that the printing terminal 5 holds the content data only for a limited period of time in which the user of the printing terminal 5 carries out the printing of the content data. As a result, an operation other than printing the content data such as copying the content data onto an external memory medium, editing the content data, etc. can be prevented from being carried out. Further, a contribution to automatically saving a resource of the HDD 530 can be made.

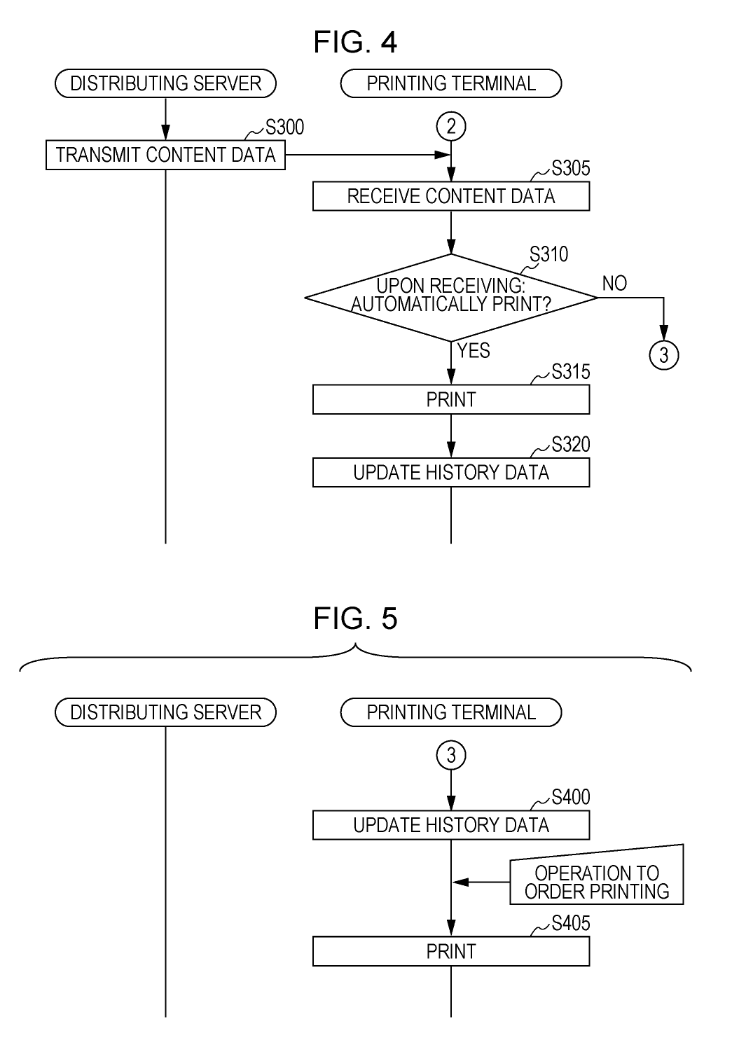

Then, a case in which the distribution service provider specifies neither compulsory printing nor the limited number of printing times in particular will be explained. In such a case, the printing system operates differently depending upon the modes in which the printing terminal 5 is set, which will be explained individually with reference to FIGS. 4 and 5.

If the controller 220 of the distributing server 2 orders neither compulsory printing nor the limited number of printing times in particular, the controller 220 transmits distribution data to which no such orders are set at the step S100, and then push-transmits content data corresponding to the distribution data to the printing terminal 5 (j, step S300 in FIG. 4). The controller 520 of the printing terminal 5 receives the content data from the distributing server 2 (step S305), and stores the content data in the HDD 530. If the limited number of printing times is identified as not being set as the limited number of times data as a result of the distribution data analysis at the step S200 (i.e., compulsory printing is not ordered and the printing data can be printed an unlimited number of times), the controller 520 identifies whether the printing terminal 5 is set in the automatic printing mode or in the manual printing mode (step S310). Upon being set in the automatic printing mode, the controller 520 transfers the content data to the printing section 550 so as to carry out printing of the content data (step S315). Then, the controller 520 updates the history data (step S320), and shows on the display section 570 that the content data has been received and automatically printed.

If the distributing side of the content data orders neither compulsory printing nor the limited number of printing times, as described above, the printing terminal 5 can automatically print the content data in accordance with the mode in which the printing terminal 5 is set.

Upon identifying the printing terminal 5 as not being set in the automatic printing mode, i.e., as being set in the manual printing mode at the step S310, the controller 520 updates the history data (FIG. 5, step S400) and shows the history data on the display section 570. In this case, the controller 520 shows the user on the display section 570 that, e.g., one unit of content data which has been received and has not been printed yet exists. Besides, the controller 520 can show, e.g., a title, an explaining text or thumbnails of the content data which has not been printed, the date and time of distribution of the distribution data, a fact that the content data is not limited in the number of printing times (can be printed an unlimited number of times), etc. together. If there is a plurality, the controller 520 shows that in a list so that the user can choose an individual matter from the plurality by operating the operation section 560.

Then, the controller 520 waits, without printing the content data, to accept an operation of the user to order printing of the content data which has not been printed. If the operation is done, the controller 520 accepts the operation and transfers the content data stored in the HDD 530 to the printing section 550 so as to carry out the printing of the content data (step S405).

If the distributing side of the content data orders neither compulsory printing nor the limited number of printing times, as described above, the printing terminal 5 can automatically print the content data in accordance with the mode in which the printing terminal 5 is set in accordance with the user's operation to order the printing.

After receiving and printing the content data in one of the four procedures explained above with reference to FIGS. 2 to 5, the printing terminal 5 again exchanges a request and a response to cancel the session in accordance with the SIP. As a result, the session between the distributing server and the printing terminals 5, 6 is cancelled. Incidentally, if the printing terminal 5 receives the content data in accordance with the user's operation to order the printing as described above, the session can be cancelled after the printing terminal receives the distribution data. In that case, the controller 520 again carries out the procedures for establishing a session with the distributing server 2 in accordance with the SIP after accepting the operation to order the printing.

### 2. Other Embodiments

Incidentally, the technical scope of the present invention is not limited to the embodiment described above. The embodiment can be variously modified without deviating from the gist of the present invention as a matter of course. The transmitting terminal 1 of the above embodiment, e.g., can have the function of the distributing server 2 by itself. Further, a printing terminal can transmit distribution data and content data to another printing terminal, and the printing terminal on the transmitting side can control a request for printing the content data, the limited number of printing times, etc. on the printing terminal on the receiving side.

Further, a same mechanism as that of the above embodiment can be used so that the distribution data and the content data are transmitted from the side of the printing terminals 5, 6 of the client to the terminal of the distribution service provider, and that a request for printing or a limitation on the number of printing times can be controlled on the user's side of the printing terminals 5, 6. Further, according to the above embodiment, the SIP clients belong to, although not limited to as a matter of course, two different domains as explained above. Further, the above embodiment is aimed at a network including the Internet, and can be aimed at, e.g., an in-house LAN. Moreover, another method can be partially or totally used for communication instead of the SIP protocol so that distribution data or content data is distributed.

Further, the SIP server can collect state data of the SIP client as required. The distributing server 2 can obtain the state (whether being powered on or off, a state of printer supplies, etc.) of the printing terminals 5, 6, choose an available one from printing terminals of destinations enumerated on the destination list and distribute the distribution data and the content data. In that case, the distributing server 2 can leave a printing terminal to which none of the distribution data and the content data is distributed as distribution history data.

Further, if the printing terminal is unable to receive distribution data or content data or is unable to print the content data owing to some error on the side of the printing terminal, the printing terminal can notify the distributing server 2 of an error occurrence. Further, upon being notified of the error occurrence, the distributing server 2 can retransmit the distribution data or the content data to the printing terminal on which the error occurred. If the error occurrence is not solved in spite of several times of retransmission, the distributing server 2 can leave the printing terminal on which the error occurred as well as the content of the error as the distribution history data.

What is claimed is:

1. A printing terminal which is connectable to a distributing server via a communication line, the printing terminal comprising:
a limited number of times data receiving section which receives from the distributing server limited number of times data indicating a limit on the number of printing times of content data to be printed;
an accepting section which accepts a user's operation to order printing of the content data;
a content data receiving section which receives the content data;
a printing section which carries out the printing of the content data upon the accepting section accepting the operation to order the printing; and
a printing controller which prevents the content data from being printed by the printing terminal upon the number of printing times of the content data on the printing terminal reaching the limit on the number of printing times indicated by the limited number of times data after the printing is carried out.

2. The printing terminal according to claim 1, wherein:
the accepting section accepts the operation to order the printing after the limited number of times data receiving section receives the limited number of times data; and
the content data receiving section receives the content data upon the accepting section accepting the operation to order the printing.

3. The printing terminal according to claim 1, wherein the printing controller discards the content data from the printing terminal upon the number of printing times reaching the limit on the number of printing times.

4. The printing terminal according to claim 1, further comprising a request data receiving section which receives request data concerning a request for carrying out the printing of the content data, the request data being related to every unit of the content data, wherein the printing controller carries out the printing of the content data regardless of the operation to order the printing upon the request data requesting that the printing be carried out irrelevantly to the operation to order the printing.

5. A distributing server which is connectable to a printing terminal via a communication line, the printing terminal comprising:
a limited number of times data distributing section which distributes limited number of times data indicating a limit on the number of printing times of content data to be printed; and
a content data distributing section which distributes the content data to a destination of the limited number of times data.

6. A method for controlling a printing terminal, comprising the steps of:
receiving limited number of times data indicating a limit on the number of printing times of content data to be printed, the content data being distributed from a distributing server;
accepting a user's operation to order printing of the content data;
receiving the content data distributed from the distributing server;
controlling the printing by carrying out the printing and preventing the content data from being printed by a printing terminal upon the number of printing times of the content data on the printing terminal reaching the limit on the number of printing times indicated by the limited number of times data after the printing is carried out.
